(19) United States
(12) Patent Application Publication
(10) Pub. No.: US 2016/0062925 A1
(43) Pub. Date: Mar. 3, 2016

(54) METHOD AND SYSTEM FOR MANAGING STORAGE DEVICE OPERATIONS BY A HOST DEVICE

(71) Applicant: Samsung Electronics Co., Ltd., Suwon-si (KR)

(72) Inventor: Dilip SURAPURAM, Hyderabad (IN)

(21) Appl. No.: 14/834,538

(22) Filed: Aug. 25, 2015

(30) Foreign Application Priority Data
Aug. 28, 2014 (IN) 4205/CHE/2014

(51) Int. Cl. G06F 13/16; G06F 13/18; G06F 13/42

(52) U.S. Cl. CPC G06F 13/1642; G06F 13/4282; G06F 13/1689; G06F 13/18

(57) ABSTRACT

The various embodiments herein provide a method and system for managing storage device operations by a host device. The method comprises of receiving, by a device controller, at least one operation command with a high priority from a host device and information of pausing one or more logical units; triggering a pause command to pause execution of the one or more logical units if the priority of the received operation command is high; and triggering a resume command to resume the execution of the one or more logical units being paused once the operation command with higher priority is executed. This way data traffic can be reduced for high priority operation, in order to execute high priority operation faster.

### CROSS-REFERENCE TO RELATED APPLICATION

This application claims priority from Indian Patent Application No. 4205/CHE/2014 filed on Aug. 28, 2014 in the Indian Intellectual Property Office, and all the benefits accruing therefrom under 35 U.S.C. 119, the entire contents of which are herein incorporated by reference in their entirety.

### BACKGROUND

Example embodiments of the inventive concepts generally relate to device management. For example, at least some example embodiments relate to a method and/or system for managing storage device operations by a host device.

Applications running on a host machine (e.g. a smart device) may require instantaneous and simultaneous access to a plurality of memory devices. These applications may demand the host machine to perform certain operations on the memory devices simultaneously and quickly. Conventionally, the host machine may issue operations to the memory devices and wait for the memory devices to complete the operations, and, thus, these conventional host devices may not have control over the operations other than the ability to terminate the operations. For example, the host device may be unable to regulate processing of a high priority operation while the memory devices are processing other operations or at runtime.

Further, a conventional memory protocol may share data traffic among different logical units if multiple operations need to be executed simultaneously in different logical units. However, these multiple operations may include certain operations, for example a read, write, verify, format, synchronize cache, purge (secure removal), background and other device specific operations, that can take a relatively long period of time to perform and may consume a relatively large amount of data traffic. If the priority of an operation, executed at a logical unit, has increased at run time, then the host device may be unable to manage different logical units.

In view of the foregoing, there is a need for a method and system for executing operations based on runtime priority without disturbing the present operation sequence of different logical units. There is also a need for a method and system which reduces the wait time and processing time for executing operations based on priority.

### SUMMARY

Example embodiments of the inventive concepts can be implemented in numerous ways, including at least as a method, system and/or device. Several non-limiting example embodiments of the inventive concepts are discussed below.

At least some example embodiments relate to a method and system for managing storage device operations using a pause and resume of logical units.

Other example embodiments of the inventive concepts relate to a method and system for reducing the data traffic and execution time of high priority operations.

Other example embodiments of the inventive concepts relate to a method and system for managing a storage device in multiple logical unit scenarios and multiple operation execution scenarios.

At least some example embodiments of the inventive concepts relate to a method and/or system of managing storage device operations by a host device.

In some example embodiments, the method includes receiving, by a device controller, at least one operation command with a high priority from a host device, wherein the at least one operation command comprises an information which indicates the device controller to pause one or more logical units, triggering a pause command to pause one or more logical units in a device, and triggering a resume command to resume the execution of the one or more logical units being paused once the operation command with higher priority is executed.

According to an example embodiment of the inventive concepts, the pause command for one or more logical units is triggered by the host device.

According to an example embodiment of the inventive concepts the resume command of one or more logical units is triggered by at least one of the host device or the device controller.

According to an example embodiment of the inventive concepts, the method of triggering the pause command of one or more logical units provides for accepting a plurality of incoming operation commands to logical units, waiting for an ongoing operation cycle of on ongoing operation command in that logical unit to be completed, pausing one or more background operations and releasing one or more resources held by the ongoing operation before pausing the logical unit.

According to an example embodiment of the inventive concepts, the pause command of one or more logical units is transmitted to the device controller as a separate command from the host device.

According to an example embodiment of the inventive concepts, the pause command of one or more logical units is transmitted to the device controller along with the operation command with high priority as a single message.

Some example embodiments also relate to a system for managing storage device operations.

In some example embodiments, the system includes of a device controller adapted for receiving, by a device controller, at least one operation command with a high priority from a host device, wherein the at least one operation command comprises an information which indicates the device controller to pause one or more logical units, and a host device adapted triggering a pause command to pause one or more logical units in a device; and triggering a resume command to resume the execution of the one or more logical units being paused once the operation command with higher priority is executed.

According to an example embodiment of the inventive concepts, the resume command of one or more logical units which are paused is triggered by at least one of the host device or the device controllers.

According to an example embodiment of the inventive concepts, the device controller is further adapted for accepting a plurality of incoming operation commands, waiting for an ongoing operation cycle to be completed, pausing one or more background operations and releasing one or more resources held by the ongoing operation before pausing.

According to an example embodiment of the inventive concepts, the pause command of one or more logical units is transmitted to the device controller as a separate command from the host device.

According to an example embodiment of the inventive concepts, the pause command of one or more logical units is transmitted to the device controller along with the operation command with high priority as a single message.

At least some example embodiments relate to a device controller.

In some example embodiments, the device controller includes a receiver configured to receive an operation command from a host device, the operation command including information identifying a high priority operation; a memory device configured to store data therein; and a controller configured to, pause execution of one or more logical units not associated with the high priority operation, and execute the high priority operation after pausing the one or more logical units.

The foregoing has outlined, in general, at least some example embodiments of the inventive concepts and is to serve as an aid to better understanding the more complete detailed description which is to follow. In reference to such, there is to be a clear understanding that the example embodiments of the inventive concepts are not limited to that described and illustrated herein. It is intended that any other advantages and objects of the example embodiments of the inventive concepts that become apparent or obvious from the detailed description or illustrations contained herein are within the scope of example embodiments of the inventive concepts.

### BRIEF DESCRIPTION OF THE DRAWINGS

The above and other features and advantages of example embodiments of the inventive concepts will become more apparent by describing in detail some example embodiments thereof with reference to the attached drawings in which:

FIG. 1 is a block diagram illustrating a system for managing storage device operations according to an example embodiment of the inventive concepts;

FIG. 2 is a block diagram illustrating a memory system executing pause operation of a logical unit, according to an example embodiment of the inventive concepts;

FIG. 3 is a flowchart illustrating an exemplary method of managing storage device operations by a host device, according to an example embodiment of the inventive concepts; and

FIG. 4 is a block diagram of an exemplary electronic device, showing various components for implementing embodiments of the present subject matter, according to an example embodiment of the inventive concepts.

### DETAILED DESCRIPTION

Some example embodiments will be described in detail with reference to the accompanying drawings. Example embodiments of the inventive concepts, however, may be embodied in various different forms, and should not be construed as being limited only to the illustrated example embodiments. Rather, these example embodiments are provided as examples so that this disclosure will be thorough and complete, and will fully convey the inventive concepts to those skilled in the art. Accordingly, known processes, elements, and techniques may not be described with respect to some of the example embodiments of the inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the example embodiments of the inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular example embodiments only and is not intended to be limiting of the example embodiments of the inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this present inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Some example embodiments of the inventive concepts relate to a method and/or system for managing storage device operations by a host device. In the following detailed description of the example embodiments of the inventive concepts, reference is made to the accompanying drawings that form a part hereof, and in which are shown by way of illustration specific example embodiments. These example embodiments are described in sufficient detail to enable those skilled in the art to practice the example embodiments of the inventive concepts, and it is to be understood that other example embodiments may be utilized and that changes may be made without departing from the scope of example embodiments of the inventive concepts. The following detailed description is, therefore, not to be taken in a limiting sense, and the scope of example embodiments of the inventive concepts are defined only by the appended claims.

Some example embodiments of the inventive concepts relate to a method of processing high priority tasks/emergency tasks quickly (or, alternatively, instantly) without aborting/disturbing the present operation sequence of different logical units. Some example embodiments herein may reduce the execution time of high priority operations. Conventionally, operations done on one logical unit associated with a memory device may affect the speed of operation on other logical units associated with the same memory device.

Different logical units of same memory device controller may share a same fixed amount of bandwidth available between the host device and the memory device controller as well as the bandwidth between the memory device controller and memory device.

Example embodiments of the inventive concepts may allow the high priority operations to complete quickly by controlling the traffic of other logical units. For example, at least some example embodiments of the inventive concepts relate to a method of pausing and resuming one or more of the logical units automatically and when the host device requests the same.

According to some example embodiments of the inventive concepts, when a high priority or emergency operation is performed, the host device may issue a pause command to pause one or more of the logical units to increase the turnaround time of the high priority or emergency operation. Further, the host device may resume the paused logical units once the high priority or the emergency operation is completed. Also, the paused logical units can automatically be resumed by the device controller on completion of ongoing high priority operation.

When the device controller receives a pause command for one or more logical units or a high priority command with information of pausing one or more logical units, the device controller may save the state of the paused logical unit for resuming the paused operations later. According to some example embodiments, the operations herein are commands/operations defined in standard storage protocol (SCSI).

According to an example embodiment of the inventive concepts, the high priority process can be a process related to a camera in a mobile phone, where a high resolution image is stored in the memory device once a picture is captured or a page-swap request. Similarly, a low priority process can be a process related to file copy or cache synchronization on some other logical unit (LU). Conventionally, after capturing a first picture, a user may have to wait to capture another picture due to the time required to save the first picture to a memory device. Saving pictures to the memory device can be considered a high priority operation which may be executed faster with example embodiments of the inventive concepts. For example, the high priority process can further include a process which reads a page from virtual memory in case of page out, a process which displays an image once the image is selected to be viewed by the user, a process which updates meta data after actual file data in low power conditions of host (emergency conditions), a process performs a purge operation immediately for a security issue and accesses virtual memory residing on secondary storage devices.

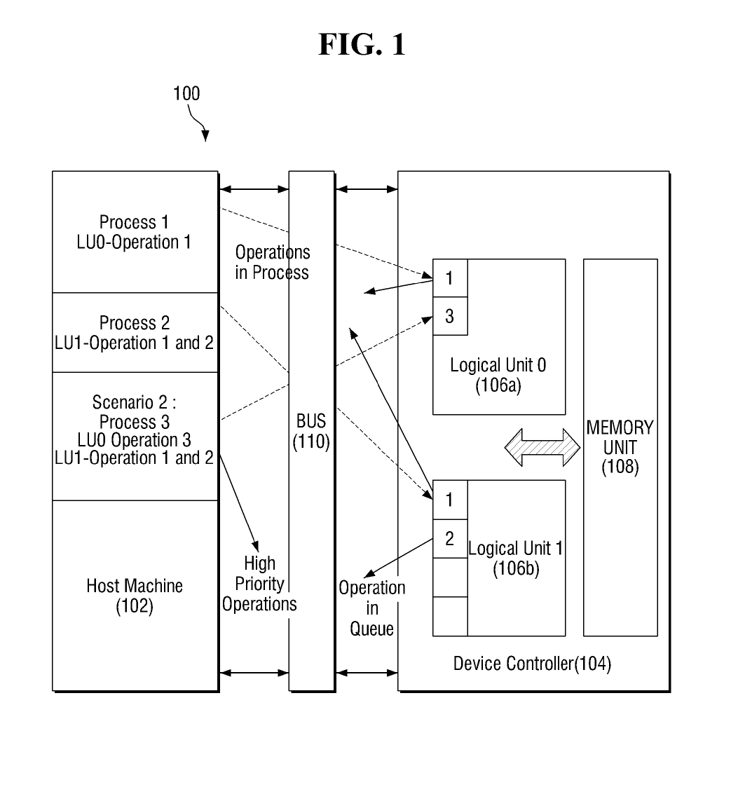

FIG.1 is a block diagram illustrating a system for managing storage device operations according to an example embodiment of the inventive concepts.

Referring to FIG.1, a system 100 a host device 102 may include a device memory to execute one or more operations. In some example embodiments, the host device 102 may be embodied as a computing device such as a personal computer, laptop, mobile phone, digital camera, a tablet, a phablet, a digital recording and play back device, a PDA, a memory card reader, an interface hub, etc.

The host device 102 may be coupled to a device controller 104 via a bus 110. The device controller 104 may include a memory unit 108 and a plurality of logical units 106a, 106b and so on.

In one or more embodiments, the host device 102 can build at least one command, such as a single command or a list of commands. A list of commands can include two or more commands.

The host device 102 may notify the memory unit 108 via a command message sent over the bus 110 that the at least one command is ready for execution, and that the host device 102 has allocated data buffers and status buffers in the host device's 102 memory. The message can also contain a pointer to a location (e.g., an address) within the memory of the host device 102 where the at least one command is located. After the host device 102 notifies the memory unit 108 that the at least one command is ready for execution, the host device 102 may relinquish control of the execution of the at least one command in the command list to the memory unit 108. The host device 102 may also relinquish control of the bus 110 between the host device 102 and the memory unit 108.

The host device 102 may send input information to the memory unit 108. For example, the host device 102 may explicitly provide input information, such as, a read request, a write request, or an erase request, to the memory unit 108.

The host device 102 may include a processor and a memory (not shown).

The processor may be a central processing unit (CPU), a controller, or an application-specific integrated circuit (ASIC), that, when executing instructions stored in the memory, configures the processor as a special purpose computer configured to determine if an operation is a high priority operation, and transmit an instruction to the device controller 104 instructing the device controller 104 to prioritize the operation and pause one or more logical units if an operation is determined to be a high priority operation. Therefore, the host device 102 may improve the functioning of the system 200 itself by increasing the amount of available bandwidth between the host device 102 and the device controller 104.

The instructions may include a computer program, a piece of code, or some combination thereof, to independently or collectively instruct and/or configure the processor to operate as desired, thereby transforming the processor into a special purpose processor. Software and data may be embodied permanently or temporarily in any type of machine, component, physical or virtual equipment, and/or computer storage medium or device. The software also may be distributed over network coupled computer systems so that the software is stored and executed in a distributed fashion. The software and data may be stored by one or more computer readable recording mediums.

The memory may a hard disk, floppy disk, magnetic tape; optical media such as CD ROM disks and DVD; magneto-optical media such as optical disks; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter.

The input information may include a command, an address, and/or priority information. When the command is a write command, the input information may also include write data. The input information may be transmitted in a packet or may be transmitted through a desired (or, alternatively, a predetermined) port including a plurality of pins.

The host device 102 may determine which particular operation of a plurality of operations in a multiple operation scenario has to execute relatively faster. The memory unit 108 may read, write, or erase data according to the input information received from the host device 102.

The device controller 104 may include a controller (not shown).

The controller may be a central processing unit (CPU), a processor, or an application-specific integrated circuit (ASIC), that, when executing instructions stored in the memory, configures the controller as a special purpose computer configured to pause processing certain operations when executing high priority operations associated with logical units. Further, the instructions may configure the processor to accept incoming operations while executing the high priority operations, and hold processing of these incoming operations until the logical units execute the high priority operations. Therefore, the device controller 104 including the processor may improve the functioning of the system 200 itself by increasing the amount of available bandwidth between the host device 102 and the device controller 104.

In some example embodiments, the logical units may be arithmetical logic units (ALU), for example, a digital electric circuit configured to perform arithmetic and bitwise logical operations on binary numbers, and output a result of the operation, for example, to the host device 102. In other example embodiments, the logical units may be functional software blocks configured to perform the same.

When an operation command is received from the host device 102, the device controller 104 may determine whether the priority of the received operation command is high and whether the command includes information requesting that the device controller 104 pause one or more logical units. If the device controller 104 finds that the received operation command is of higher priority and has information requesting that one or more of the logical units be paused, then the device controller 104 may pause one or more of the logical units. Further, the device controller 104 may resume operation of the paused logical units once the high priority operation command is completed.

Before triggering the pause of the logical units, the device controller 104 may wait for the logical unit to complete an operation cycle of an ongoing operation and determine that all resources held by the operation are released before changing the state of the logical unit to pause.

During the pause of the logical units, the device controller 104 may accept incoming operations associated with the logical units but may pause processing these incoming operations including any background operations. Therefore, the device controller 104 may decrease the data traffic in accessing NAND and system memory. The paused logical units may not send any data-in packets or RTT packets to the host device 102.

In some example embodiments of the inventive concepts, the pause operation of one or more logical units is triggered by the host device 102. Therefore, the host device 102 may control the processing operations and hence reduce the data traffic and run high priority operations quickly (or, alternatively, instantly). Also, after the pause operation of one or more logical units is triggered by the host device 102, the operations of the one or more logical units may be resumed either by the host device 102 or the operations may be reduced via an automatic action.

In an example embodiment of the inventive concepts, operations can include but not limited to a read, a write, verify, synchronize cache, or format operations that are issued to the memory unit 108.

According to an example embodiment of the inventive concepts, an operation cycle may be defined as follows if a read operation in a logical unit is to be paused. The device controller 104 may read some fixed amount of data from the memory unit 108, form a data packet and send the data packet to the host machine 102. This procedure may be carried out until the device controller 104 has completed sending the requested amount of data. The process of reading the fixed amount of data, forming the data packet and sending the data packet to the host machine may be considered to be one operation cycle. Similarly, the operation cycle for other operations that are executed in the logical unit are defined.

After completion of an operation cycle of an operation, and before starting a new operation cycle, the device controller 104 may save the state of the operation. For example, if a read request is of size 1 MB and maximum size of data-in is 32 k/64 k, then there exists 32/16 cycles to complete the request. The state of the operation may be stored as an entry in the logical unit (LU) queue. For example, considering the read request mentioned above, the entry in the LU queue corresponds to information relating to starting LBA as (X), number of LBAs as (Y) and some other information. After the fifth cycle of the read operation, the device controller 104 may have read z LBAs and sent data-in packets for those LBAs. After completion of fifth cycle, if the device controller 104 or the host device 102 wants to pause the operation, then the device controller 104 may store the state of the operation. After completing the data transfer of Z LBAs, the device controller 104 may update this information in the corresponding entry in LU queues. Upon updating the LU queue entry, the device controller 104 processes the other operation(s). Here, the paused operation may be treated as a new read operation with starting LBS as (X-Z) and number of LBAs as (Y-Z).

To resume the paused logical unit, the device controller 104 may read the entry in the LU queue and start performing operation in the logical unit. This is similar to processing a new operation belonging to that logical unit. Once pause of a certain operation is requested from the host device 102, the device controller 104 may wait for ongoing cycle to be completed and make sure that operation associated with the ongoing cycle releases all the resources held by that particular operation before changing the state of the logical unit to pause. Hence, to pause and resume a logical unit, the device controller 104 may utilize the cycle definition and extra information stored for resuming an operation.

According to an example embodiment, the pause and resume operations of logical units may not require any major extra resources to save the state of ongoing operation since the state information (2-4 bytes of extra information) may be saved in the same entry in logical unit queue. Further, the resumption of an operation may be similar to processing of a new operation. The operation may be resumed using the extra information stored while pausing. The time consumed in saving the required information may be very minimal (almost negligible).

Referring to FIG. 1, conventionally, a high priority operation may remain in a wait mode while the device controller processes two logical units 106a, 106b in parallel. Further, even if the high priority operation is executed, the high priority operation may have to share the available bandwidth with logical unit 1 (LU1) 106b, which may increase the execution time of the high priority operation.

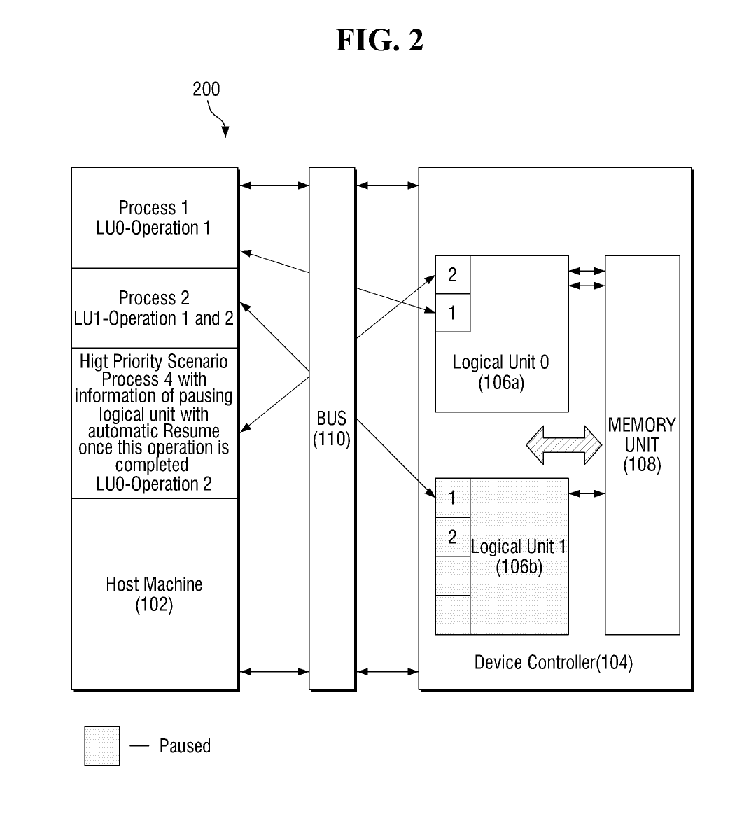

FIG. 2 is a block diagram of a memory system executing pause operation of a logical unit, according to an example embodiment of the inventive concepts.

Referring to FIG. 2, two logical units are processed in parallel by a device controller 104 with a high priority operation being executed after the other logical units are paused. Before triggering a pause operation when a high priority operation/command is received, the device controller 104 may accept incoming requests but pause the processing of these incoming operations and background operations belonging to paused logical units.

Also, the device controller 104 may wait for an ongoing operation's cycle to be completed in a logical unit before pausing the logical units. Once the ongoing operation is about to complete, then the device controller 104 may decide to either pause the logic unit or let the operation complete. To pause the logical unit, the device controller 104 may store extra information so as to resume the logical unit after a desired (or, alternatively, a pre-defined) time from the paused state. Upon pausing the logical unit, the device controller 104 may determine whether the paused logical unit is holding any resources. Once the device controller 104 has determined that all other operations are completed, device controller 104 may trigger the resumption of paused logical units automatically, unless there is any restriction from the host device 102.

FIG. 2 illustrates a scenario where a high priority operation is executed after pausing other logical units in the device controller 104, in order to reduce the data traffic for high priority operation.

According to an example embodiment of the inventive concepts, in case of a single logical unit scenario, once the high priority operation is allocated processing time, the high priority operation may not share resources and traffic with any other operation. But, in case of multiple logical unit scenarios, a high priority operation may share bandwidth and some other resources with other logical unit's operations. The bandwidth is the available data traffic between the memory unit 108 and the host device 102 and the data traffic between the memory unit 108 and the memory unit 108.

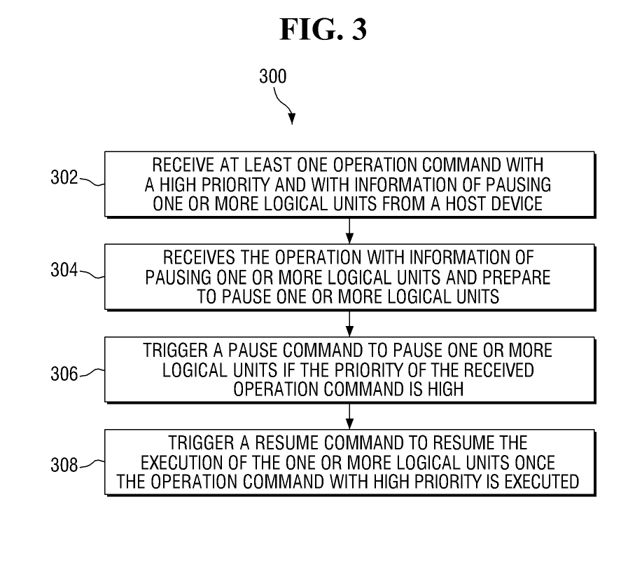

FIG. 3 is a flowchart illustrating a method of managing storage device operations by a host device according to an example embodiment of the inventive concepts.

Referring to FIG. 3, in the method 300, in operation 302, the device controller 104 receives at least one operation command with a high priority and with information requesting that one or more logical units be paused. For example, the device controller 104 may receive the at least one operation command from the host device 102.

In operation 304, the device controller 104 may prepare to pause one or more logical units.

In operation 306, the device controller 104 may trigger a pause command to pause the one or more logical units. The device controller 104 may continue to accept a plurality of incoming operations while pausing the one or more logical units, and may wait for an ongoing operation cycle to be completed, pausing one or more background operations and releasing one or more resources held by the ongoing operation before pausing logical unit.

In operation 308, the one or more paused logical units may resume execution once the operation command with the higher priority is executed. For example, in some example embodiments, the device controller 104 may trigger the resumption of the logical units. In other example embodiments, the logical units may resume automatically.

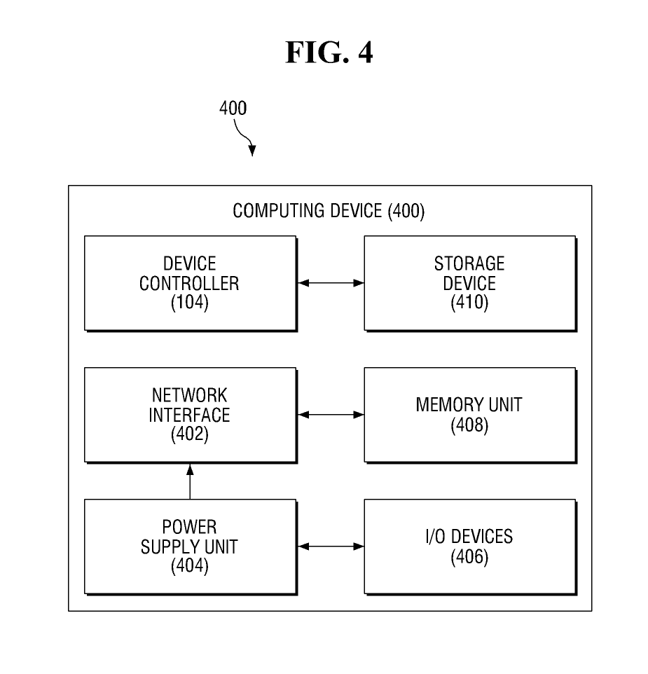

FIG. 4 is a block diagram of a computing device according to an example embodiment of the inventive concepts.

Referring to FIG. 4, the computing device 400 may include a device controller 104, a network interface 402, a power supply unit 404, a storage device 410, a memory 408 and I/O devices 406. However, example embodiments are not limited thereto. For example, the computing device 400 may include additional components not shown in FIG. 4. For example, the computing device 400 may also include a microphone and speaker, in examples where the computing device is capable of making telephone calls. The computing device 400 may also include a battery that provides power to the components of the computing device 400. The computing device 400 may also include user interface components, such as a keypad, trackball, mouse, or other such user interfaces that allow the user to interact with computing device 400. Moreover, the components of the computing device 400 shown in FIG. 4 may not be necessary in every example of the computing device 400.

In some example embodiments, the computing device 400 may be embodied as a desktop computer, a laptop computer or a computing device such as smart phone, tablet computer, Phablet and the like.

The device controller 104 may execute a plurality of logic gates or control instructions implemented in a hardware form or a firmware form and perform various data operations on the memory unit 408 according to commands issued by the host device 102.

The device controller 104 may be configured to receive at least one operation command with a high priority and information of pausing one or more logical units from a host device, verify the information of pausing one or more logical units, trigger a pause command to pause execution of the one or more logical units to decrease the data traffic for high priority operation and trigger a resume command to resume the execution of the one or more paused logical units once the operation command with higher priority is executed. Further, the device controller 104 may be configured to read a page from a virtual memory in case of a page out, display an image selected for viewing by the user, update metadata after executing actual file data in low power conditions of the host device, perform a purge operation for security issues on an urgent basis and access data from the virtual memory residing on secondary storage devices. Furthermore, the device controller 104 may be configured to accept a plurality of incoming operation commands, wait for an ongoing operation cycle to be completed, pause one or more background operations and release one or more resources held by the ongoing operation before pausing.

The network interface 402 is configured to provide access to a network, such as a local area network. The network interface 402 may include, for example, a wireless network interface having an antenna. In one embodiment, the network interface 402 may provide access to the local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

The power supply unit 404 comprises appropriate hardware (including memory) and/or software for implementing the power management functions of the example embodiments of the inventive concepts.

The I/O device 406 may include or have access to one or more user input devices and one or more output devices such as a mouse, a keyboard, a display, and a printer. It should be understood that the I/O device 406 is not limited to the devices described above and may further include other devices.

The computing device 400 may be configured to store information in the memory 408 during operation. The memory 408 may, in some examples, be described as a computer-readable storage medium. The memory 408 may be described as a volatile memory, meaning that the memory does not maintain stored contents when the computer is turned off. Examples of volatile memories include random access memories (RAM), dynamic random access memories (DRAM), static random access memories (SRAM), and other forms of volatile memories known in the art. In some examples, the memory 408 may be used to store program instructions for execution by the device controller 104.

The storage device 410 may include one or more computer-readable storage media. The storage device 410 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the storage device 410 may, in some examples, be considered a non-transitory storage medium. The term “non-transitory” may indicate that the storage medium is not embodied in a carrier wave or a propagated signal. However, the term “non-transitory” should not be interpreted to mean that the storage device 410 is non-movable. In some examples, the storage device may 410 be configured to store larger amounts of information than the memory. In certain examples, a non-transitory storage medium may store data that can, over time, change (e.g., in Random Access Memory (RAM) or cache).

Example embodiments have been described with reference to some example embodiments. It will be evident that various modifications and changes may be made to these example embodiments without departing from the broader spirit and scope of the various example embodiments. Furthermore, the various devices, modules, and the like described herein may be enabled and operated using hardware circuitry, firmware, and/or software embodied in a machine readable medium. Although the example embodiments are described with various specific example embodiments, it will be obvious for a person skilled in the art to practice the inventive concepts with modifications. However, all such modifications are deemed to be within the scope of the claims. It is also to be understood that the following claims are intended to cover all of the generic and specific features of the example embodiments described herein and all the statements of the scope of the embodiments which as a matter of language might be said to fall there between.

What is claimed is:

1. A method of managing a storage device, the method comprising:
transmitting at least one operation command with a high priority from a host device to a device controller;
instructing the device controller to pause one or more logical units; and
resuming execution of the one or more logical units, if the operation command with higher priority finishes executing.

2. The method of claim 1, wherein the instructing instructs the device controller to pause the one or more logical units via a pause command triggered by the host device.

3. The method of claim 1, wherein the resuming is triggered in response to a resume command, the resume command being generated by at least one of the host device or the device controller.

4. The method of claim 1, wherein the instructing instructs the device controller to,
accept a plurality of incoming operation commands;
wait for an ongoing operation cycle to complete;
pause one or more background operations; and
release one or more resources held by the ongoing operation before pausing the one or more logical units.

5. The method of claim 1, further comprising:
transmitting the pause command to the device controller as a separate command from the at least one operation command.

6. The method of claim 1, further comprising:
transmitting the pause command to the device controller along with the operation command as a single message.

7. A system for managing storage device operations, the system comprising:
a device controller configured to,
receive at least one operation command with a high priority from a host device,
pause one or more logical units based on at least the at least one operation command, and
resume the execution of the one or more logical units, if the operation command with higher priority finishes executing; and
a host device configured to instruct the device controller to pause execution of the one or more logical units.

8. The system as claimed in claim 7, wherein the device controller is configured to resume the execution of the one or more logical units in response to a resume command, the resume command being generated by at least one of the host device and the device controller.

9. The system as claimed in claim 7, wherein the device controller is further configured to,
accept a plurality of incoming operation commands;
wait for an ongoing operation cycle to be completed;
pause one or more background operations; and
release one or more resources held by the ongoing operation before pausing the one or more logical units.

10. The system as claimed in claim 7, wherein the host device is configured to instruct the device controller to pause the one or more logical units via a pause command, the pause command being a separate command from the at least one operation command.

11. The system as claimed in claim 7, wherein the host device is configured to instruct the device controller to pause the one or more logical units via a pause command transmitted to the device controller along with the operation command as a single message.

12. A device controller comprising:
a receiver configured to receive an operation command from a host device, the operation command including information identifying a high priority operation;
a memory device configured to store data therein; and
a controller configured to,
pause execution of one or more logical units not associated with the high priority operation, and
execute the high priority operation after pausing the one or more logical units.

13. The device controller of claim 12, wherein the controller is further configured to resume execution of the one or more logical units, if execution of the high priority operation is complete.

14. The device controller of claim 13, wherein the controller is configured to resume execution of the one or more logical units without further commands from the host device.

15. The device controller of claim 13, wherein the controller is configured to resume execution of the one or more logical units, if the device controller receives a resume command, via the receiver, from the host device.

16. The device controller of claim 15, wherein the operation command and the resume command are transmitting via standard storage protocol (SCSI) commands.

17. The device controller of claim 12, wherein the controller is configured to pause execution of the one or more logical units by,
waiting for an ongoing operation cycle associated with the one or more logical units to complete,
release one or more resources held by the ongoing operation, and
pause the one or more logical units after the one or more resources are released.

18. The device controller of claim 12, wherein the high priority operation is one or more of a read request, a write request and an erase request.

19. The device controller of claim 18, wherein the high priority operation is associated with an image captured by the host device, and the pausing pauses the one or more logical units not associated with the image.

20. The device controller of claim 12, wherein the one or more logical units that are paused are unable to send data to the host device.
